(19) United States
(12) Patent Application Publication
(10) Pub. No.: US 2026/0037181 A1
(43) Pub. Date: Feb. 5, 2026

(54) PERFORMING MULTIPLE MEMORY OPERATIONS IN A MEMORY SUB-SYSTEM

(71) Applicant: Micron Technology, Inc., Boise, ID (US)

(72) Inventors: Yu-Chung Lien, San Jose, CA (US); DeWei Lai, Zhubei City (TW); Dheeraj Srinivasan, San Jose, CA (US); Zhenming Zhou, San Jose, CA (US)

(21) Appl. No.: 18/791,055

(22) Filed: Jul. 31, 2024

(51) Int. Cl. G06F 3/06

(52) U.S. Cl. CPC G06F 3/0659; G06F 3/0613; G06F 3/0679

(57) ABSTRACT

One or more processing devices in a memory sub-system determine that a first segment and a second segment of a memory device of the memory sub-system are to be programmed. First programming metadata for the first segment is determined. Second programming metadata for the second segment is determined. Responsive to determining the first programming metadata and the second programming metadata, the first and the second segment are caused to be programmed based on the first programming metadata and the second programming metadata.

### TECHNICAL FIELD

Embodiments of the disclosure relate generally to memory sub-systems, and more specifically, relate to performing multiple memory operations in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various aspects of the disclosure.

FIG. 1 illustrates an example computing system that includes a memory sub-system, according to some aspects of the disclosure.

FIG. 2A illustrates a waveform that when applied to a memory segment, causes a memory operation to be performed, according to some aspects of the disclosure.

FIG. 2B illustrates a series of waveforms that when applied to segments of a memory device, cause multiple memory operations to be performed, according to some aspects of the disclosure.

FIG. 3A is an example visual representation of a command sequences for performing memory operations, according to some aspects of the disclosure.

FIG. 3B is an example visual representation of a command sequences for performing memory operations, according to some aspects of the disclosure.

FIG. 4A is a flow diagram of an example method for determining a metadata for performing multiple memory operations in a memory sub-system, according to some aspects of the disclosure.

FIG. 4B is a flow diagram of an example method for determining a metadata for performing multiple memory operations in a memory sub-system, according to some aspects of the disclosure.

FIG. 5 is a flow diagram of an example method for determining a metadata for performing multiple memory operations in a memory sub-system, according to some aspects of the disclosure.

FIG. 6 is a block diagram of an example computer system in which embodiments of the disclosure can operate.

### DETAILED DESCRIPTION

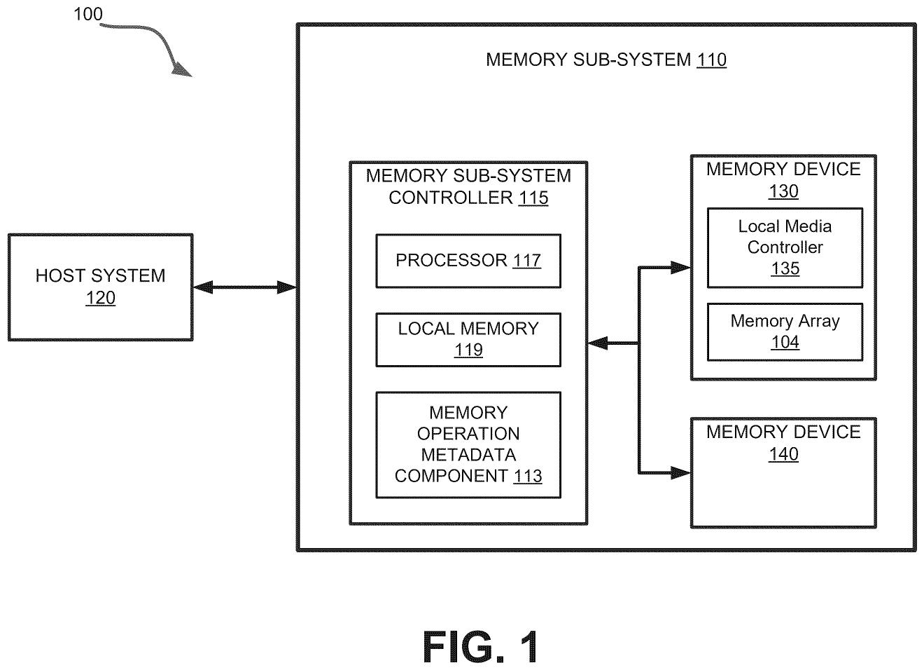

Aspects of the present disclosure are directed to performing multiple memory operations in a memory sub-system. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where data retention of data is desired when no power is supplied to the memory device. For example, NAND memory, such as 3D flash NAND memory, offers storage in the form of compact, high density configurations. A non-volatile memory device is a package of one or more dice, each including one or more planes. For some types of non-volatile memory devices (e.g., NAND memory), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane.

The speed at which data can be programed to-, read from-, or erased from a memory device significantly impacts the responsiveness and efficiency of the system. Faster memory operations (e.g., programming operations, read operations, erase operations, etc.) can reduce latency and improve access to data stored on the memory device. When memory operations can be performed faster, the energy requirements for a memory device can be decreased, as voltages are applied to the memory device for shorter durations. Additionally, when voltages are applied for longer durations to the memory device, the physical structure of the memory device is more likely to experience a decrease in reliability.

In particular, faster performance of memory operations on NAND flash memory can be particularly beneficial due to the manner in which NAND flash memory operations are performed on the memory device. A NAND flash memory operation can be performed by applying a voltage value to a segment of a memory device (a set of memory cells, etc.) for a certain duration. Some memory operations can be performed by applying multiple voltage values for varying durations. Together, these multiple voltage values and varying durations can be represented as a “signal waveform” or “waveform.” Often, the longer that a voltage is applied, the more likely that the desired value is stored. However, long applications of voltages, as described above, can increase memory latency, increase energy requirements, and decrease the reliability of the memory device.

Some memory sub-systems attempt to mitigate these challenges by shortening the duration of certain portions of a memory operation. For example, a shorter program pulse may be used, or a shorter delay between program pulses or program operations may be used. However, as described above, shorter voltage pulses and/or shorter delays between application of voltages can affect the reliability of data stored on the memory device. Other memory sub-systems attempt to mitigate these challenges by organizing memory operations into more efficient batches. For example, memory operations that will be performed on close (or adjacent) areas of a memory device can be grouped together into a batch of memory operations, which may reduce the time it takes the memory sub-system to perform the memory operations. However, these changes can only provide so much improvement in efficiency.

Aspects of the present disclosure address the above and other deficiencies by performing multiple memory operations in a memory sub-system. The metadata can include duration data and voltage data that represent a signal waveform to perform a memory operation. By determining multiple signal waveforms for multiple memory operations at the same time, a signal waveform does not need to be determined separately before each memory operation that is performed, which can reduce the time in between memory operations. In some embodiments, determining multiple signal waveforms all together can be faster than determining signal waveforms at the time the memory operation is to be performed. For example, a controller of the memory device can access a table that indicates multiple durations and corresponding voltages for memory operations based on certain characteristics.

In some embodiments, the memory sub-system can determine a number of programming operations that will be performed. The memory sub-system can determine, for each programming operation, a corresponding signal waveform. The corresponding signal waveforms can be stored in association with a programming queue including the programming operations. When a programming operation is to be performed, the corresponding signal waveform that was previously determined can be used.

Advantages of the approach described herein include, but are not limited to, improved performance in the memory sub-system. For example, accessing this table continuously to determine multiple values for multiple waveforms can be more efficient than accessing this table to determine values for a first waveform, performing the memory operation with the first waveform, and then accessing the table again to determine values for a second waveform.

FIG. 1 illustrates an example of a computing system 100 that includes a memory sub-system 110 in accordance with some aspects of the disclosure. The memory sub-system 110 can include media, such as one or more volatile memory devices (e.g., memory device 140), one or more non-volatile memory devices (e.g., one or more memory device(s), such as memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a computer express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) such as memory device 130) when the memory sub-system 110 is coupled with the host system 120 by the physical host interface (e.g., PCIe or CXL interface). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

Memory device 130 and memory device 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include not-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s), such as memory device 130, can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each memory device 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory device 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, electrically erasable programmable read-only memory (EEPROM).

A memory sub-system controller 115 (or memory sub-system controller 115 for simplicity) can communicate with the memory device(s) (e.g., memory device 130) to perform operations such as reading data, writing data, or erasing data at the memory device 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) (e.g., memory device 130). The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device 130. The memory sub-system controller 115 can further include host interface circuitry to communicate with the host system 120 via the physical host interface. The host interface circuitry can convert the commands received from the host system into command instructions to access the memory device(s) (e.g., memory device 130) as well as convert responses associated with the memory device(s) (e.g., memory device 130) into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) (e.g., memory device 130).

In some embodiments, the memory device(s) (e.g., memory device 130) include local media controllers 135 that operate in conjunction with memory sub-system controller 115 to execute operations on one or more memory cells of the memory device(s) (e.g., memory device 130). An external controller (e.g., memory sub-system controller 115) can externally manage the memory device 130 (e.g., perform media management operations on the memory device(s) (e.g., memory device 130)). In some embodiments, a memory device 130 is a managed memory device, which is a raw memory device (e.g., memory array 104) having control logic (e.g., local media controller 135) for media management within the same memory device package. An example of a managed memory device is a managed NAND (MNAND) device. Memory device(s) (e.g., memory device 130), for example, can each represent a single die having some control logic (e.g., local media controller 135) embodied thereon. In some embodiments, one or more components of memory sub-system 110 can be omitted.

In some embodiments, the memory sub-system 110 includes a memory operation metadata component 113 that can determine metadata to be used for performing multiple memory operations. In some embodiments, the memory operation metadata component 113 can determine the metadata for performing each of the multiple memory operations before performing the multiple memory operations. In some embodiments, determining metadata for each of the memory operations all at the same time (before performing any of the memory operations) reduces the time that it takes to perform all of the multiple memory operations on the memory device.

In some embodiments, the metadata can indicate how a memory operation is performed on a segment of memory. For example, a memory operation can be performed by applying a certain voltage to a segment of memory for a certain period of time. The application of various voltages for various periods of time to the segment of memory can be referred to as a memory operation waveform, or “waveform” as used herein. The “shape” of the waveform applied to the segment of the memory device can be determined by the values of the metadata (e.g., time data and corresponding voltage data).

In some embodiments, the memory operation metadata component 113 can determine some or all of the metadata for a memory operation by reading data from a data structure (e.g., a table). In some embodiments, the memory operation metadata component 113 can determine some or all of the metadata for a memory operation using one or more algorithms. In some embodiments, the metadata can be relational. That is, the metadata can indicate a deviation from a standard value, based on physical or logical characteristics of the segment of memory, the memory operation, or the like. Further details with regards to the operations of memory operation metadata component 113 are described below.

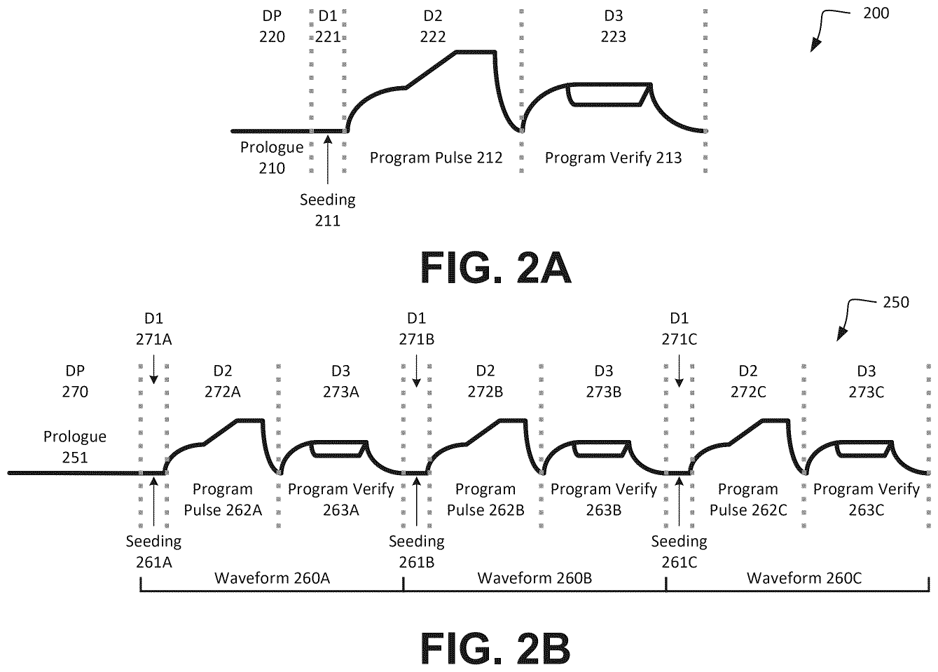

FIG. 2A illustrates a waveform 200 that when applied to a memory segment, causes a memory operation to be performed, according to some aspects of the disclosure. The waveform 200 can be separated into multiple portions, and includes one or more of a prologue 210, seeding 211, program pulse 212, and program verify 213.

During the prologue 210, the size and shape (e.g., characteristics) of the remaining portions of the waveform 200 are determined. In some embodiments, a controller, such as local media controller 135 of FIG. 1 determines the characteristics of the waveform 200. In some embodiments, the controller can determine a first voltage value for seeding 211, a second voltage value for program pulse 212, and a third voltage value for program verify 213. In some embodiments, multiple voltage values can be determined for each portion of the waveform. For example, a first voltage value, a second voltage value, and a third voltage value can be determined for the program pulse 212. In some embodiments, the controller can determine a first duration “D1” 221 to apply a first voltage for seeding 211, a second duration “D2” 222 to apply a second voltage for program pulse 212, and a third duration “D3” to apply a third voltage for program verify 213. In some embodiments, (not illustrated) multiple durations corresponding to multiple voltage values can be determined for a labeled portion of the waveform. For example, a first duration for a first voltage value for program pulse 212 and a second duration for a second voltage value for program pulse 212 can be determined. In some embodiments, a duration of the prologue duration DP 220 can be based on a duration of time it takes the controller to determine the characteristics of the waveform 200. That is, the faster that the controller can determine the characteristics of the waveform 200, the shorter the duration of the prologue duration DP 220.

In some embodiments, the duration of the memory operation is based on the time that it takes to determine the waveform 200, and apply the waveform 200 to the segment of the memory device. In the illustrated example, the duration of the memory operation corresponding to the waveform 200 can be represented as the sum of DP 220, “D1” 221, “D2” 222, and “D3” 223. It can be appreciated that performing the memory operation again (or a similar memory operation, such as on another segment of memory) would have the same duration, represented as the sum of DP 220, “D1” 221, “D2” 222, and “D3” 223.

In some embodiments, the waveform 200 can include additional portions (not illustrated), such as one or more of a pre-programming pulse portion, a program pulse recovery portion, a program verify initialization portion, a timing compensation portion, a program verify pre-charge portion, a voltage boost compensation portion, a voltage sensing portion, or a recovery portion. In some embodiments, the additional portions listed above can be included in one or more of the illustrated portions, such as seeding 211, program pulse 212, or program verify 213. For example, the program pulse recovery portion can be a part of the program pulse 212 as illustrated in FIG. 2A. In some embodiments, the waveform 200 can include multiples of the same portion. For example, the waveform 200 can include a first program pulse (e.g., program pulse 212) and a second program pulse (e.g., similar to program pulse 212) between seeding 211 and program verify 213.

FIG. 2B illustrates a series of waveforms 250 that when applied to segments of a memory device, cause multiple memory operations to be performed, according to some aspects of the disclosure. In some embodiments, the series of waveforms 250 can include portions of multiple waveforms, such as waveform 200 of FIG. 2A. The series of waveforms 250 can correspond to performing multiple memory operations, with each waveform 250 corresponding to a respective memory operation.

The series of waveforms 250 include prologue 251, waveform 260A, waveform 260B, and waveform 260C. In some embodiments, the waveform 260A, waveform 260B, and waveform 260C can be the same as or similar to the portions of the waveform 200 including the seeding 211, program pulse 212, and program verify 213. For example, waveform 260A can include a seeding 261A (e.g., corresponding to seeding 211), a program pulse 262A (e.g., corresponding to program pulse 212), and program verify 263A (e.g., corresponding to program verify 213). In another example, waveform 260B can include a seeding 261B (e.g., corresponding to seeding 211), a program pulse 262B (e.g., corresponding to program pulse 212), and program verify 263B (e.g., corresponding to program verify 213). In another example, waveform 260C can include a seeding 261C (e.g., corresponding to seeding 211), a program pulse 262C (e.g., corresponding to program pulse 212), and program verify 263C (e.g., corresponding to program verify 213).

It can be noted that the waveform 260A, waveform 260B, and waveform 260C do not include respective prologues. Instead, as illustrated the series of waveforms 250 include a single prologue 251 that is performed before the three waveforms. During the prologue 251, the size and shape (e.g., characteristics) of the waveform 260A, the waveform 260B, and the waveform 260C are determined. In some embodiments, a controller, such as the local media controller 135 of FIG. 1 determines the characteristics of each of the waveforms. For example, as similarly described above in FIG. 2A, the controller can determine a first voltage value for seeding 261A, a second voltage value for program pulse 262A, a third voltage value for program verify 263A, a fourth voltage value for seeding 261B, a fifth voltage value for program pulse 262B, a sixth voltage value for program verify 263B, a seventh voltage value for seeding 261C, an eighth voltage value for program pulse 262C, and a ninth voltage value for program verify 263C. In another example, as similarly described above in FIG. 2A, the controller can determine a first duration “D1” 271A for seeding 261A, a second duration “D2” 272A for program pulse 262A, a third duration “D3” 273A for program verify 263A, a fourth duration “D1” 271B for seeding 261B, a fifth duration “D2” 272B for program pulse 262B, a sixth duration “D3” 273B for program verify 263B, a seventh duration “D1” 271C for seeding 261C, an eighth duration “D2” 272C for program pulse 262C, and a ninth duration “D3” 273C for program verify 263C.

In some embodiments, the prologue 251 has a longer prologue duration DP 270 than the prologue duration DP 220 of the prologue 210 of FIG. 2A. In some embodiments, the prologue duration DP 270 for determining the characteristics for “N” waveforms is shorter than a combined duration of N number of prologue durations DP 220. In some embodiments, additional improvements in the duration of a programming operation can be realized by performing the prologue 251 for multiple waveforms. For example, and in some embodiments, entering into and exiting from the prologue (e.g., a prologue 210) in between each waveform of a series of waveforms (e.g., series of waveforms 250) may require certain conditions that to create in the memory device may increase the duration of the series of waveforms 250. In a particular example, the duration of the prologue 251 (or the prologue 210) can be dependent on a temperature of the memory device. As memory operations are performed, the temperature of the memory device may increase, causing the duration DP 220 of the prologue 210 to increase over time. Determining the characteristics for the waveform 260A, the waveform 260B, and the waveform 260C (and additional waveforms in a series of programming operations) during the prologue 251 can avoid increases in duration that may otherwise occur when performing multiple prologue operations in between each waveform (e.g., waveform 200). In another example, the program verify operation (e.g., program verify 213 of FIG. 2A) performed before a subsequent prologue operation (e.g., prologue 210) can affect the duration of the subsequent prologue operation.

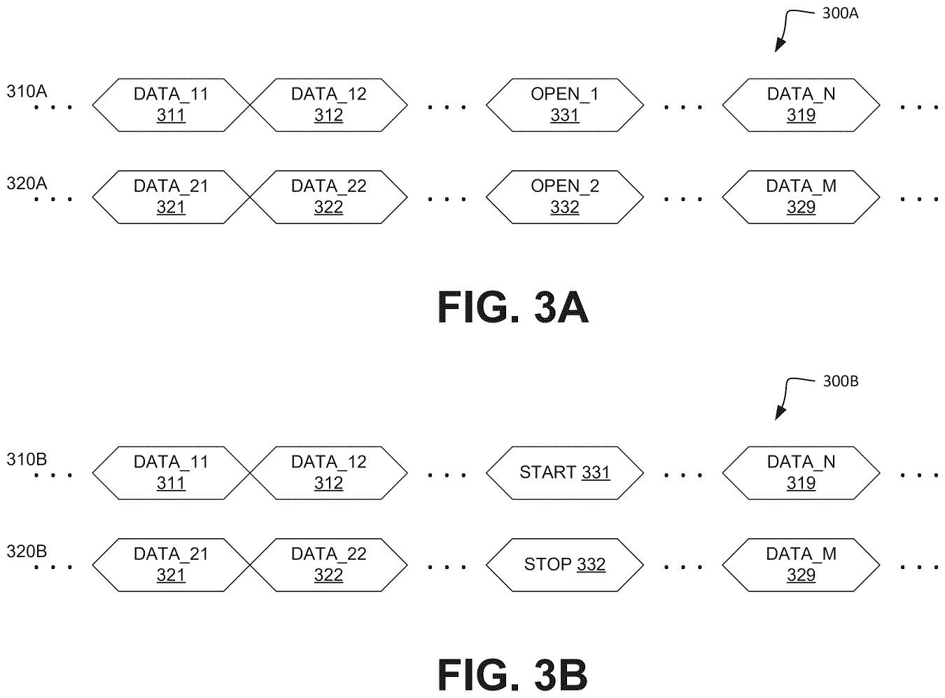

FIG. 3A is an example visual representation of a command sequences 300A for performing memory operations, according to some aspects of the disclosure.

A first command sequence 310A includes DATA_11 311, DATA_12 312, OPEN_1 331, and DATA_N 319. A second command sequence 320A includes DATA_21 321, DATA_22 322, OPEN_2 332, and DATA_M 329. In some embodiments, the command sequences 300A can include unused portions of the sequence. These unused portions (illustrated here as OPEN_1 331 and OPEN_2 332) can be used to add additional functionality to the command sequences 300A. In particular, with relation to performing multiple memory operations in a memory sub-system, these unused portions can contain data or information necessary to perform multiple memory operations after an initial pre-programming operation (e.g., a prologue portion, or operation to determine values and timing for signals to perform the memory multiple memory operations).

FIG. 3B is an example visual representation of a particular command sequence 300B for performing multiple memory operations after an initial pre-programming operation (e.g., a “prologue”), according to some aspects of the disclosure.

The first command sequence 310B can include the same elements as the first command sequence 310A, except that the OPEN_1 331 element of the first command sequence 310A is replaced with the START 331 element. In some embodiments, the START 331 element can include information that identifies which memory operation waveform(s) have already been determined (e.g., during the aggregated pre-programming, or prologue operation). In some embodiments, the START 331 element can include an address of a first segment of the memory device that corresponds to the first determined waveform (e.g., waveform 260A of FIG. 2B).

The second command sequence 320B can include the same elements as the second command sequence 320A, except that the OPEN_2 332 element of the second command sequence 320A is replaced with the STOP 332 element. In some embodiments, the STOP 332 element can include information that identifies which memory operation waveform(s) have already been determined (e.g., during the aggregated pre-programming, or prologue operation). In some embodiments, the STOP 332 element can include an address of a last segment of the memory device that corresponds to the last determined waveform (e.g., waveform 260A of FIG. 2B).

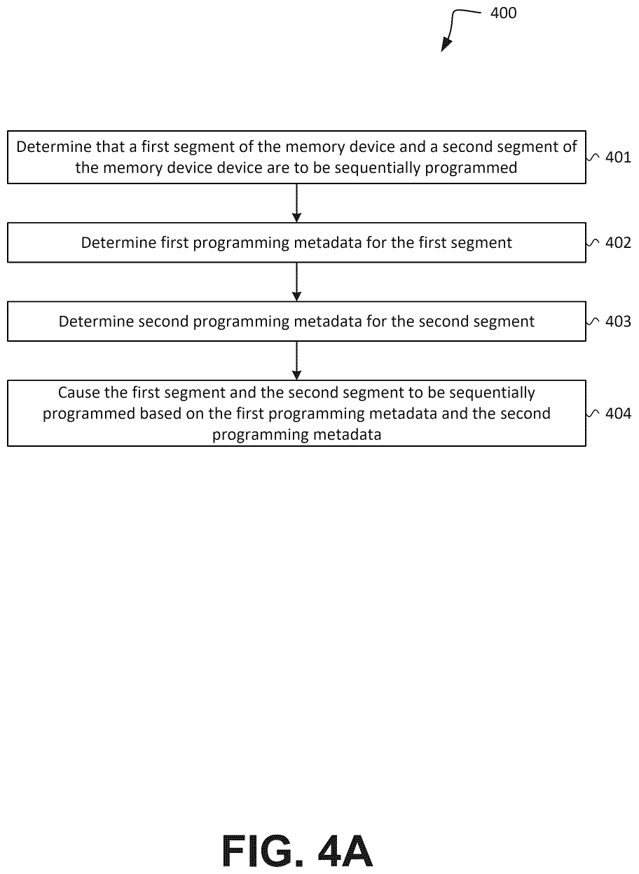

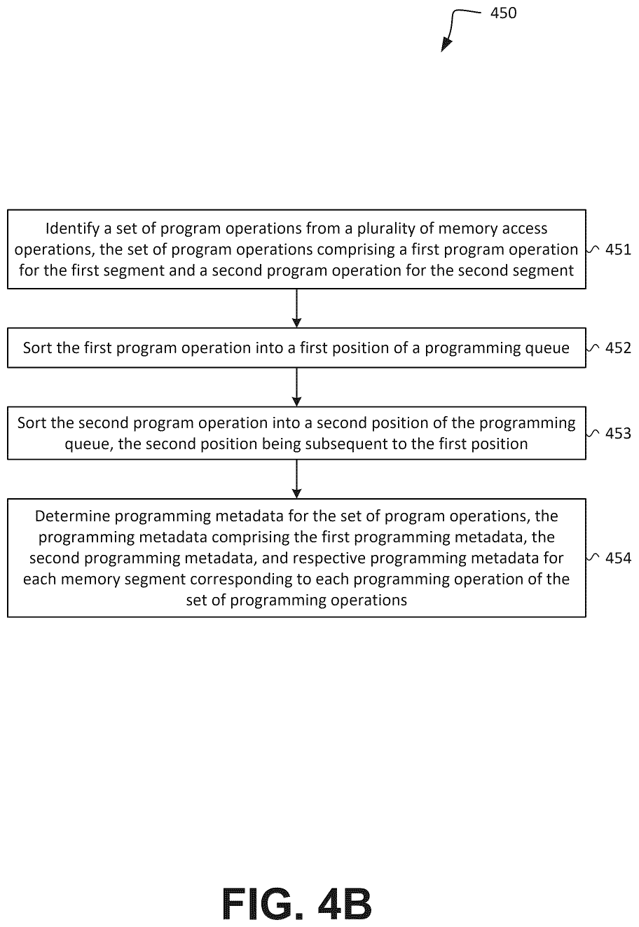

FIG. 4A is a flow diagram of an example method 400 for determining a metadata for performing multiple memory operations in a memory sub-system, according to some aspects of the disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by memory operation metadata component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 401, the processing logic determines that a first segment of the memory device and a second segment of the memory device device are to be programmed. In some embodiments, the first and second segment of the memory device are to be programmed sequentially, that is the second segment is to be programmed immediately after the first segment. In some embodiments, the processing logic determines that a first memory operation and a second memory operation are to be performed on a first segment and a second segment. In some embodiments, the first and second memory operations can be one or more of a programming operation, an erase operation, a read operation, or the like.

At operation 402, the processing logic determines first programming metadata for the first segment. In some embodiments, determining the first programming metadata for the first segment includes determining one or more characteristics of a waveform to be applied to the first segment for a programming operation to be performed on the first segment. In some embodiments, the one or more characteristics can include timing data or voltage data. For example, timing data can indicate a length of time the waveform should maintain a certain voltage represented by the voltage data.

In some embodiments, to determine the first programming metadata for the first segment, the processing logic uses a table of characteristics of a waveform that correspond to the first segment. In some embodiments, the table of characteristics can include one or more of timing data or voltage data that is specific to the first segment. For example, due to the physical or logical location of the first segment, manufacturing techniques or defects, or current conditions of the memory device, the first segment can have a table of characteristics that is different from a second segment. In some embodiments, these characteristics can be represented as deviations from a standard value. For example, the first segment can be associated with a +0.1 volts (compared to a standard memory operation voltage) for −0.1 microseconds (μs) (compared to a standard memory operation duration). In some embodiments, to determine the first programming metadata for the first segment, the processing logic uses a table of characteristics of a waveform that correspond to a particular memory operation. In some embodiments, the table of characteristics can include one or more of timing data or voltage data that is specific to the memory operation (e.g., erase, read, program, etc.), as is similarly described above. In some embodiments, the table of characteristics can include one or more of timing data or voltage data that is specific to the memory operation and the first segment.

In some embodiments, to determine the first programming metadata for the first segment, the processing logic calculates one or more of a voltage value or a duration value based on characteristics of the memory device (e.g., the segment of the memory device). For example, and in some embodiments, a temperature of the memory segment can affect the first programming metadata used to apply a programming waveform to the first segment. In another example and in some embodiments, a duration of time that data has been stored to the first segment can affect the first programming metadata used to apply the programming waveform to the first segment. In some embodiments, additional variables, such as a type of program operation can affect the first programming metadata. In some embodiments, the processing logic can use multiple table(s) as described above in combination with predetermined relationships between the multiple table(s) to determine the programming metadata for the first segment. For example, the processing logic can use a table related to characteristics of the first segment (such as physical abnormalities, manufacturing defects, etc.), a table related to the type of memory operation (e.g., program operation, erase operation, read operation, etc.), and a table related to current conditions of the memory device (e.g., temperature, time data has been stored in the memory device, or a specific segment of the memory device, etc.).

At operation 403, the processing logic determines second programming metadata for the second segment. In some embodiments, the programming metadata (either the first or second programming metadata) can include timing metadata for programming the first or second segment of the memory device. In some embodiments, the programming metadata (either the first or second programming metadata) can include voltage biasing metadata. For example, voltage biasing metadata can indicate an adjustment to a programming voltage for a particular portion of a programming operation for a segment of the memory device.

At operation 404, the processing logic causes the first segment and the second segment to be programmed based on the first programming metadata and the second programming metadata. In some embodiments to program the first segment, the processing logic causes a first control signal to be sent to a wordline driver. The first control signal causes the wordline driver to apply a first waveform having first determined waveform characteristics to a first wordline (e.g., the first segment, or portion of the first segment). In some embodiments, the wordline driver can apply the first waveform having the first determined waveform characteristics to additional wordlines (e.g., a segment, or portions of a segment). In some embodiments, to program the second segment, the processing logic causes a second control signal to be sent to the wordline driver. The second control signal causes the wordline driver to apply a second waveform having second determined waveform characteristics to a second wordline (e.g., the second segment or portion of the second segment). In some embodiments, the first control signal is sequentially followed by the second control signal, such that the first segment is programmed, and then the second segment is sequentially programmed. In some embodiments, the first segment is a first portion of a first wordline and the second segment is a second portion of the first wordline. The first control signal causes the wordline driver to apply the first waveform to the first portion of the first wordline, and the second control signal causes the wordline driver to apply the second waveform to the second portion of the first waveform.

In some embodiments, a programming queue has been organized to prioritize sequential programming. In such embodiments, the first segment and the second segment can be programmed from the organized programming queue.

FIG. 4B is a flow diagram of an example method 450 for determining a metadata for performing multiple memory operations in a memory sub-system, according to some aspects of the disclosure. The method 450 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 450 is performed by memory operation metadata component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible. In some embodiments, the method 450 can be performed as a part of the operation 401 of FIG. 4A, as described above.

At operation 451, the processing logic identifies a set of program operations from a plurality of memory access operations, the set of program operations comprising a first program operation for the first segment and a second program operation for the second segment.

At operation 452, the processing logic sorts the first program operation into a first position of a programming queue.

At operation 453, the processing logic sorts the second program operation into a second position of the programming queue, the second position being subsequent to the first position.

At operation 454, the processing logic determines programming metadata for the set of program operations. For example, the processing logic can determine the first programming metadata (of the programming metadata) for, or based on the first program operation, then the processing logic can determine the second programming metadata (of the programming metadata) for, or based on the second program operation, etc. In some embodiments, the programming metadata includes respective programming metadata for each memory segment corresponding to each programming operation of the set of programming operations. In some embodiments, programming metadata can include information for performing multiple program operations of the set of program operations. For example, a first program operation can be performed on a first segment using first programming metadata. A second program operation can be performed on a second segment using the first programming metadata.

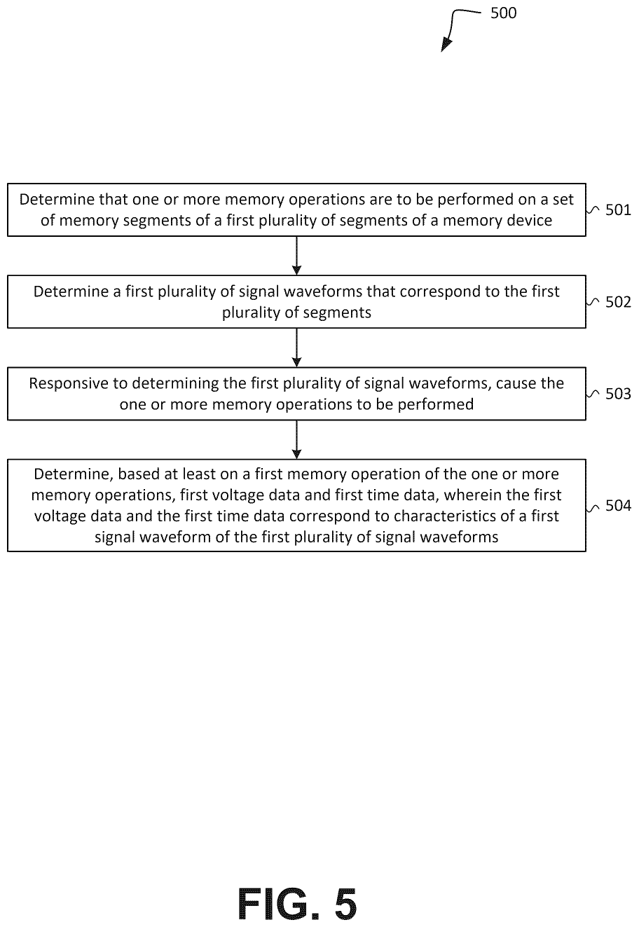

FIG. 5 is a flow diagram of an example method for determining a metadata for performing multiple memory operations in a memory sub-system, according to some aspects of the disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by memory operation metadata component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 501, the processing logic determines that one or more memory operations are to be performed on a set of memory segments of a first plurality of segments of a memory device. In some embodiments, the memory device can have multiple pluralities of segments. In some embodiments, each memory operation of the one or more memory operations corresponds to a respective segment of the first set of segments of the memory device. In some embodiments, the number of segments in the first set of segments is the same as the number of segments in the first plurality of segments, that is, the first set of segments of the first plurality of segments. In some embodiments, the first set of segments includes only some of the segments of the first plurality of segments.

At operation 502, the processing logic determines a first plurality of signal waveforms that correspond to the first plurality of segments. In some embodiments, the first signal waveform of the first plurality of signal waveforms corresponds to a first segment of the first plurality of segments. That is, in some embodiments, a signal waveform can be determined for each segment that a memory operation is applied to. In some embodiments regardless of whether the set of segments includes some or all segments of the plurality of segments, when one or more memory operations are to be applied to the set of segments, signal waveforms can be determined for all segments of the plurality of segments.

At operation 503, responsive to determining the first plurality of signal waveforms, the processing logic causes one or more memory operations to be performed. In some embodiments, the one or more memory operations are performed by respectively applying each signal waveform of the first plurality of signal waveforms to each segment of the first plurality of segments.

At operation 504, the processing logic determines first voltage data and first time data. In some embodiments, the first voltage data and the first time data are determined based at least on a first memory operation of the one or more memory operations. In some embodiments, the first voltage data and the first time data are determined based at least on a first segment of the plurality of segments. In some embodiments, voltage data and time data are determined for each segment that is to be programed by a memory operation. In some embodiments, the voltage data and the time data correspond to characteristics of the signal waveform. For example, and in some embodiments, a first duration of the first time data can indicate a duration that a first voltage value of the first voltage data is to be applied to the first segment.

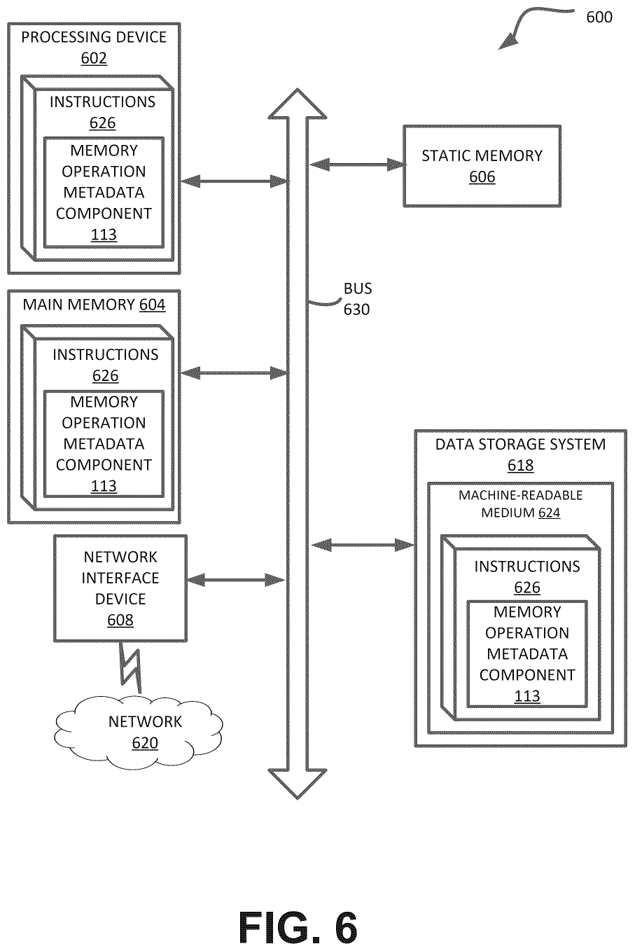

FIG. 6 illustrates an example of a computer system 600 within which a set of instructions, for causing the machine to perform any one or more of the methodologies discussed herein, can be executed, in accordance with aspects of the disclosure. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the memory operation metadata component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

In some embodiments, computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. In some embodiments, the data storage system 618 can include a computer-readable non-transitory storage medium, and can be operatively coupled to the processing device 602. The instructions 626 can also reside, completely or at least partially, within the main memory 604 and/or within the processing device 602 during execution thereof by the computer system 600, the main memory 604 and the processing device 602 also constituting machine-readable storage media. In some embodiments, the instructions 626 can be refer to executable instructions. The machine-readable storage medium 624, data storage system 618, and/or main memory 604 can correspond to the memory sub-system 110 of FIG. 1.

In some embodiments, the instructions 626 include instructions to implement functionality corresponding to the memory operation metadata component 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory sub-system comprising:
a memory device; and
one or more processing devices operatively coupled to the memory device, the one or more processing devices to perform operations comprising:
determining that a first segment of the memory device and a second segment of the memory device are to be programmed;
determining first programming metadata for the first segment;
determining second programming metadata for the second segment; and
responsive to determining the first programming metadata and the second programming metadata, causing the first segment and the second segment to be programmed based on the first programming metadata and the second programming metadata.

2. The memory sub-system of claim 1, the operations further comprising:
determining that a third segment of the memory device is to be programmed with the first segment and the second segment;
determining third programming metadata for the third segment; and
causing the third segment to be programmed with the first segment and the segment based on the third programming metadata.

3. The memory sub-system of claim 1, wherein determining the first programming metadata for the first segment is based on one or more characteristics of the first segment of the memory device.

4. The memory sub-system of claim 1, wherein the first programming metadata comprises timing metadata for a programming operation to be performed on the first segment.

5. The memory sub-system of claim 1, wherein the first programming metadata comprises voltage biasing metadata for a programming operation to be performed on the first segment.

6. The memory sub-system of claim 1, wherein determining that the first segment and the second segment are to be programmed comprises:
identifying a set of programming operations from a plurality of memory access operations, the set of programming operations comprising a first programming operation for the first segment and a second programming operation for the second segment;
sorting the first programming operation into a first position of a programming queue; and
sorting the second programming operation into a second position of the programming queue, wherein the second position is subsequent to the first position.

7. The memory sub-system of claim 6, the operations further comprising:
determining programming metadata for the set of programming operations, the programming metadata comprising the first programming metadata, the second programming metadata, and respective programming metadata for each segment corresponding to each programming operation of the set of programming operations.

8. A method comprising:
determining that a first segment of a memory device and a second segment of the memory device are to be programmed;
determining first programming metadata for the first segment;
determining second programming metadata for the second segment; and
responsive to determining the first programming metadata and the second programming metadata, causing the first segment and the second segment to be programmed based on the first programming metadata and the second programming metadata.

9. The method of claim 8, further comprising:
determining that a third segment of the memory device is to be programmed with the first segment and the second segment;
determining third programming metadata for the third segment; and
causing the third segment to be programmed with the first segment and the segment based on the third programming metadata.

10. The method of claim 8, wherein determining the first programming metadata for the first segment is based on one or more characteristics of the first segment of the memory device.

11. The method of claim 8, wherein the first programming metadata comprises timing metadata for a programming operation to be performed on the first segment.

12. The method of claim 8, wherein the first programming metadata comprises voltage biasing metadata for a programming operation to be performed on the first segment.

13. The method of claim 8, wherein determining that the first segment and the second segment are to be programmed comprises:
identifying a set of programming operations from a plurality of memory access operations, the set of programming operations comprising a first programming operation for the first segment and a second programming operation for the second segment;
sorting the first programming operation into a first position of a programming queue; and
sorting the second programming operation into a second position of the programming queue, wherein the second position is subsequent to the first position.

14. The method of claim 13, further comprising:
determining programming metadata for the set of programming operations, the programming metadata comprising the first programming metadata, the second programming metadata, and respective programming metadata for each segment corresponding to each programming operation of the set of programming operations.

15. A computer-readable non-transitory storage medium comprising executable instructions that, when executed by a controller managing a memory device comprising a plurality of memory cells, cause the controller to perform operations comprising:
determining that a first segment of the memory device and a second segment of the memory device are to be programmed;
determining first programming metadata for the first segment;
determining second programming metadata for the second segment; and
responsive to determining the first programming metadata and the second programming metadata, causing the first segment and the second segment to be programmed based on the first programming metadata and the second programming metadata.

16. The computer-readable non-transitory storage medium of claim 15, the operations further comprising:
determining that a third segment of the memory device is to be programmed with the first segment and the second segment;
determining third programming metadata for the third segment; and
causing the third segment to be programmed with the first segment and the segment based on the third programming metadata.

17. The computer-readable non-transitory storage medium of claim 15, wherein determining the first programming metadata for the first segment is based on one or more characteristics of the first segment of the memory device.

18. The computer-readable non-transitory storage medium of claim 17, wherein the first programming metadata comprises timing metadata for a programming operation to be performed on the first segment, and wherein the first programming metadata comprises voltage biasing metadata for a programming operation to be performed on the first segment.

19. The computer-readable non-transitory storage medium of claim 15, wherein determining that the first segment and the second segment are to be programmed comprises:
identifying a set of programming operations from a plurality of memory access operations, the set of programming operations comprising a first programming operation for the first segment and a second programming operation for the second segment;
sorting the first programming operation into a first position of a programming queue; and
sorting the second programming operation into a second position of the programming queue, wherein the second position is subsequent to the first position.

20. The computer-readable non-transitory storage medium of claim 19, the operations further comprising:
determining programming metadata for the set of programming operations, the programming metadata comprising the first programming metadata, the second programming metadata, and respective programming metadata for each segment corresponding to each programming operation of the set of programming operations.
